(19) United States
(12) Patent Application Publication
(10) Pub. No.: US 2026/0196064 A1
(43) Pub. Date: Jul. 9, 2026

(54) RECOGNIZING AND DEBLURRING IMAGE FRAMES

(71) Applicant: Black Sesame Technologies Inc., San Jose, CA (US)

(72) Inventors: Zi Sian Wong, Singapore (SG); Bo Li, Singapore (SG)

(21) Appl. No.: 19/009,786

(22) Filed: Jan. 3, 2025

(51) Int. Cl. G06V 20/62; G06T 7/246; G06T 7/73

(52) U.S. Cl. CPC G06V 20/625; G06T 7/248; G06T 7/74; G06T 2207/20084

(57) ABSTRACT

Methods, systems, and apparatuses, including computer programs encoded on computer storage media, for processing a sequence of image frames. The methods comprise processing a sequence of image frames to generate output representing one or more objects detected in the sequence of image frames using a first module. For each object, a tracking ID and location data is determined, and the corresponding location data is processed to generate a group of processed images for the object. An embedding for each group of the groups of processed images is generated using a first sequence of neural network layers of a neural network, and each of the embeddings is processed using a second sequence of neural network layers of the neural network to generate respective rectification parameters for rectifying the embedding. The output comprises (i) a prediction of content and (ii) a reconstructed image for each object of the one or more objects.

### BACKGROUND

This specification relates to processing images and more particularly, to processing a sequence of image frames to recognize the content associated with the images and reconstructing deblurred images from the sequence of image frames.

An image sensor can capture a sequence of image frames and stream the sequence to a processor in real time for downstream processing. Each image frame represents a scene representing one or more objects. For example, a scene can be associated with one or more roads, and the objects can include pedestrians, vehicles, vehicle license plates, or road signs. A vehicle license plate can represent a text or textual content for identifying a corresponding vehicle.

Neural networks can be implemented for image processing. Neural networks generally include different neural network layers to process input images for different tasks, e.g., detection, classification, prediction, or segmentation.

### SUMMARY

This specification describes techniques for recognizing textual content (e.g., predicting a sequence of characters or strings) represented by one or more objects captured in a sequence of image frames and generating deblurred images for these objects captured in the sequence of image frames. The term “object” in this specification refers to any suitable objects captured in an image frame. For example, an object can include one or more road signs, billboards, or landmarks. In some situations, an object can be associated with one or more vehicles (e.g., wagons, bicycles, and motor vehicles). For example, an object can be a sticker or decal attached to a vehicle. As another example, an object can be a license plate affixed to a vehicle. For ease of illustration and understanding, the techniques described below are in connection with a license plate or a vehicle license plate.

In general, a system described in this specification is configured to process a sequence of image frames taken by an image sensor or visual sensor (e.g., a general camera, a surveillance camera, or a camera located on a vehicle). The sequence of image frames can be streamed to a processor in real time for further operations. For simplicity, the descriptions below are formulated in connection with a camera, yet one should appreciate that other suitable image sensors or visual sensors can be applied.

As described above, each of the sequences of image frames might capture one or more vehicles and corresponding license plates associated with the vehicles. The system can process the sequence of image frames as a whole to simultaneously recognize the textual context of objects in the image frames (e.g., license plates) and deblur the image frames (e.g., reconstructing images for the license plates with better qualities such as higher resolutions, etc.).

The system is also configured to pre-process the sequence of image frames before providing the sequence of images to a particular neural network. More specifically, the system is configured to detect one or more license plates captured in a sequence of image frames and generate a network input for the sequence of image frames to be processed by the particular neural network. The network input can include multiple groups of processed images, each group representing a respective license plate detected in a sequence of image frames. In some implementations, the system can implement augmentation techniques to process the network input using various techniques. The processed (or augmented) network input is provided to the neural network for further operations.

The particular neural network is configured to process the network input to simultaneously recognize textual content (e.g., represented by license plates detected in the images) and reconstruct images with modifications to one or more properties that enhance the license plates. In this specification, the neural network includes at least two task/output heads, one for the above-noted recognition and the other for the above-noted modifications, e.g., performing reconstruction or deblurring. The first output head includes multiple network layers configured to process intermediate results from previous network layers in the neural network for recognizing textual content in the network input, and the second output head includes multiple network layers configured to process the same intermediate results obtained from previous network layers in the neural network to modify the input, where the modification includes reconstruction or deblurring input images for the network input.

To address image distortions in license plates captured in the sequence of images due to the camera's position and orientation, the neural network can generate embeddings for these license plates in a feature space, and modify the embeddings to remove or reduce distortions. More specifically, instead of modifying the image frames (or processed image data serving as network input), the neural network includes a sequence of rectification layers that are structurally parallel to other network layers. The rectification layers are trained to generate a set of rectification parameters for the network input. The set of rectification parameters is applied to the embeddings (in the feature space) generated by the other network layers after processing the sequence of image frames.

The neural network with different task heads is trained jointly on common training data. More specifically, the above-described rectification layers, the two different task/output heads, and the rest of the network layers are trained jointly on the same training data. A joint loss function is formulated for the joint training process. For example, the joint loss function can be a weighted sum of a recognition loss function accounting for errors accumulated in the recognition process and a reconstruction loss function accounting for errors accumulated in reconstructed images. Details of the training data, loss functions, and training process are described below.

Particular embodiments of the subject matter described in this specification can be implemented to realize one or more of the following advantages. For example, the described techniques can improve the accuracy and efficiency of performing recognition and deblurring operations on a sequence of image frames.

Some existing techniques require a standalone rectification network for performing rectification operations directly on original images or pre-processed images to reduce distortions. Then, these techniques implement another trained neural network that is configured to process the rectified image frames for predicting the textual content of license plates and reconstructing images with higher resolutions. In other words, existing techniques typically need to train two distinct neural networks or implement two trained neural networks, which introduces a substantial overhead time that would imperil efficiency. In addition, using two distinct neural networks could introduce more errors in training and/or using since errors of the rectification process oftentimes propagate into the downstream recognition and deblurring operations. Eventually, the accuracy of the recognition and deblurring operations and that of processing image frames could be considerably impaired.

By contrast, the described techniques are advantageous over the above-noted existing techniques. First, the described techniques can improve the efficiency of training a neural network. The described techniques integrate the rectification operations in the same neural network that is configured to perform recognition and deblurring operations. The described neural network includes a sequence of rectification layers configured to generate rectification parameters. The techniques apply these trained rectification parameters to features or embeddings generated for input images by the neural network. This way, the described techniques save time and computation resources by avoiding training a standalone rectification neural network to perform rectification operations.

In addition, the described neural network is jointly trained over common training data. Thus, the model parameters for all layers (including those for the rectification layers and those for different task/output heads) are more accurately obtained since errors are minimized by optimizing a joint loss function determined for the entire neural network. The joint loss function is configured to account for errors generated from both the recognition process and the deblurring (e.g., image reconstruction) operations. The joint loss function is further configured to implicitly account for errors generated from the rectification operations provided by the rectification layers.

In addition, the described techniques can further improve the accuracy of performing inference operations of the neural network. For example, the described techniques can implement different modules for pre-processing a sequence of image frames. The described techniques can be configured to further detect one or more license plates from the sequence of image frames. The system then determines and assigns a unique tracking identifier (tracking ID) to pixels that represent a particular license plate (also referred to as “sub-images” in the following description). The tracking IDs are each associated with location information determined by the system so that the system keeps track of the position of pixels that represent the same particular license plate across multiple image frames. For example, location information can include a bounding box surrounding the license plate in an image, or pixels of an image surrounded by the bounding box. The system keeps track of the size, shape, or location of the bounding box for a license plate with the same tracking ID across different image frames.

The system can process the tracking IDs with associated location information to generate candidate sub-images and select, remove, or modify candidate sub-images according to one or more criteria such that the above-described network input is generated. This way, irrelevant information in the original sequence of image frames can be removed, and objects of interest (e.g., license plates) are then rectified. The network input thus can have a smaller size and an enhanced quality for the neural network, which could improve the efficiency and the accuracy of operations provided by the neural network, e.g., recognizing textual content of the captured license plates and reconstructing images with enhanced qualities for these license plates.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system configured to generate output data after processing input data.

FIG. 2 illustrates an example detector and tracker module configured to generate tracking IDs and location data after processing image frames.

FIG. 3 illustrates an example image processing engine configured to generate processed image data for tracking IDs and location data.

FIG. 4A illustrates examples of translational augmentation of location data.

FIG. 4B illustrates examples of rotational augmentation of location data.

FIG. 5 illustrates an example neural network for processing a network input.

FIG. 6 is a flow diagram of an example process for processing image frames.

Like reference numbers and designations in the various drawings indicate like elements.

### DETAILED DESCRIPTION

The described techniques relate to processing a sequence of images using a machine learning system. The machine learning system described in this specification is configured to detect content of interest from the sequence of images and reconstruct images with modified parameters that result in images having enhanced or better qualities (e.g., higher resolution) for one or more of the sequence of images.

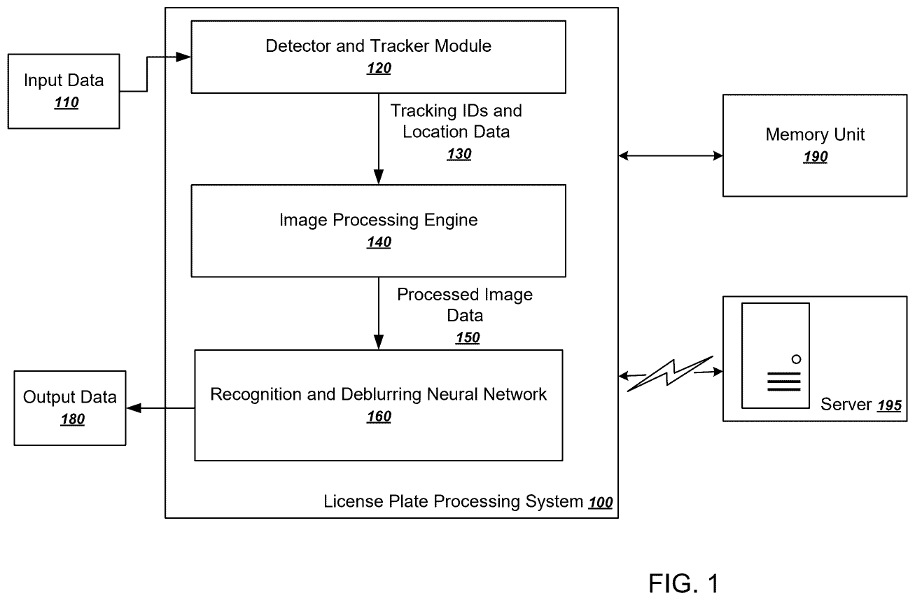

FIG. 1 illustrates an example system 100 configured to generate output data 180 after processing input data 110. The example system 100 is also referred to as a license plate processing system 100. The example system 100 can further implement a machine learning model (e.g., a neural network) and thus is also referred to as a machine learning model in this specification.

As shown in FIG. 1, the license plate processing system 100 can include one or more modules that are configured to perform different operations. For example, the license plate processing system 100 can include a detector and tracker module 120, an image processing engine 140, and a recognition and deblurring neural network 160. The license plate processing system 100 generally receives input data 110 from one or more external devices or memories and generates output data 180 using the above-noted modules.

Input data 110 generally includes image data obtained by one or more visual sensors. The character and nature of input data 110 can vary according to the type of visual sensor. For example, input data 110 can be a single-frame image collected by a camera. As another example, input data 110 can be a sequence of image frames (e.g., a video clip) collected by a video camera. In some cases, the visual sensors are configured to generate image pairs (e.g., stereo cameras), depth images (e.g., depth cameras), or other suitable image data. The input data 110 can be provided as input to the license plate processing system 100 in real-time once they are captured by corresponding cameras (e.g., a stream of image frames). In some cases, the input data 110 can be provided to license plate processing system 100 from an external memory individually or in batches, where the input data 110 can include image data collected by sensors and stored in the external memory. For simplicity of illustration, input data 110 herein are generally referred to as a sequence of input image frames and are provided to license plate processing system 100 in real time as captured by one or more image sensors.

Input data 110 can include one or more images each including one or more objects of interest. For example, one image can include one or more vehicles maneuvering on a highway, where each of the one or more vehicles is associated with a license plate. Objects of interest may vary according to different tasks and requirements and do not need to be confined to vehicles or license plates. However, for simplicity of description, the object of interest described in this specification mainly relates to a license plate.

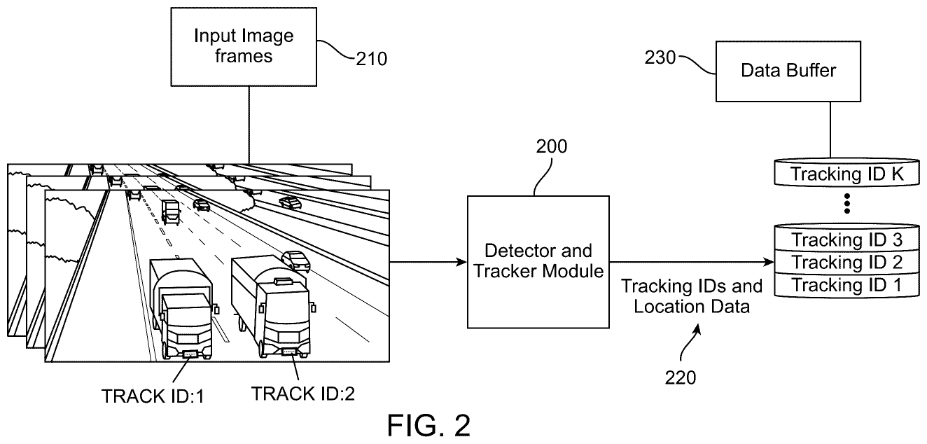

The detector and tracker module 120 is configured to process input data 110 to generate data 130. Data 130 are stored in a particular data structure. For example, for each license plate of multiple license plates captured in the sequence of image frames, data 130 generally includes a unique tracking identifier (tracking ID) that is determined and assigned to pixels (e.g., pixels of one or more images in the sequence of images) that represent a particular license plate. These pixels can also be referred to as sub-images in the corresponding image frames. In addition, each of the tracking IDs is associated with location information for pixels in different image frames. The location information is readable by other modules in the system 100 to determine the locations of pixels in each image frame, where the pixels are assigned with the same tracking ID. The location information can be further modified by other modules in system 100 to change the size and location of a bounding box in a corresponding image. Operations of the detector and tracker module 120 and tracking IDs and location data 130 are described in greater detail below in connection with FIG. 2.

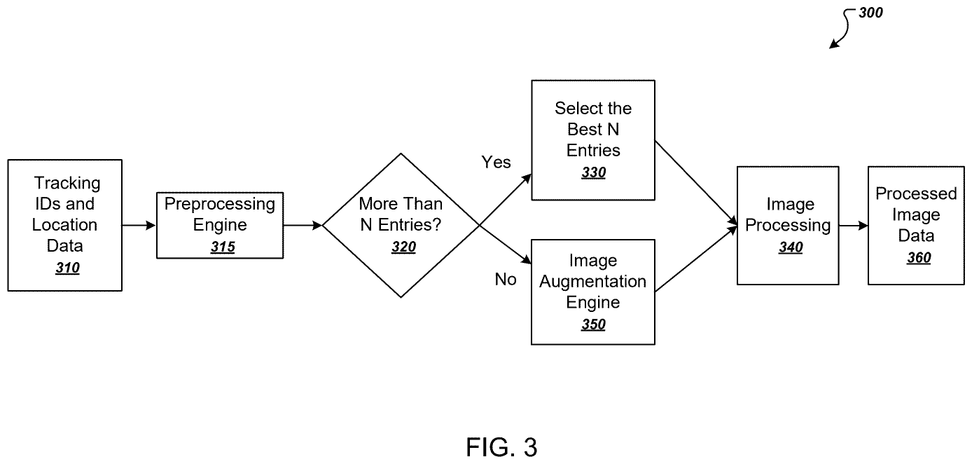

Image processing engine 140 is configured to process tracking IDs and location data 130 and generate processed image data 150. The image processing engine 140 is configured to generate sub-images from the image sequence based on the tracking IDs and location data 130, determine the quality of the sub-images (or the original input image frames) according to one or more criteria, and select ones that satisfy the one or more criteria as the processed image data 150. In some cases, the image processing engine 140 is configured to modify relevant location data 130 to improve the quality of sub-images if a portion of the sub-images do not satisfy one or more criteria. The one or more criteria can include, for example, one or more thresholds for image quality, image quantity, etc. For example, the processing engine 140 can determine whether an input image frame (or a sub-image of the input image frame) that represents a particular license plate is of good enough quality to satisfy a quality criterion. As another example, the processing engine 140 can determine whether a total number of sub-images for a particular license plate satisfies a quantity criterion. More details of the one or more criteria are described below in connection with FIG. 3.

Image processing engine 140 is configured to modify relevant data in tracking IDs and location data 130 to ensure the above-noted criteria are substantially satisfied. For example, image processing engine 140 is configured to remove one or more sub-images if they fail to satisfy the quality criterion. As another example, image processing engine 140 is configured to augment one or more sub-images to satisfy the quantity criterion.

Once the above-noted criteria are satisfied, image processing engine 140 generates processed image data 150 based on the modified tracking IDs and location data 130. Processed image data 150 generally include one or more groups of sub-images. Each group includes modified pixels representing a particular license plate that has been captured in the sequence of image data (e.g., input data 110). The processed image data 150 are then provided as a network input to recognition and deblurring neural network 160.

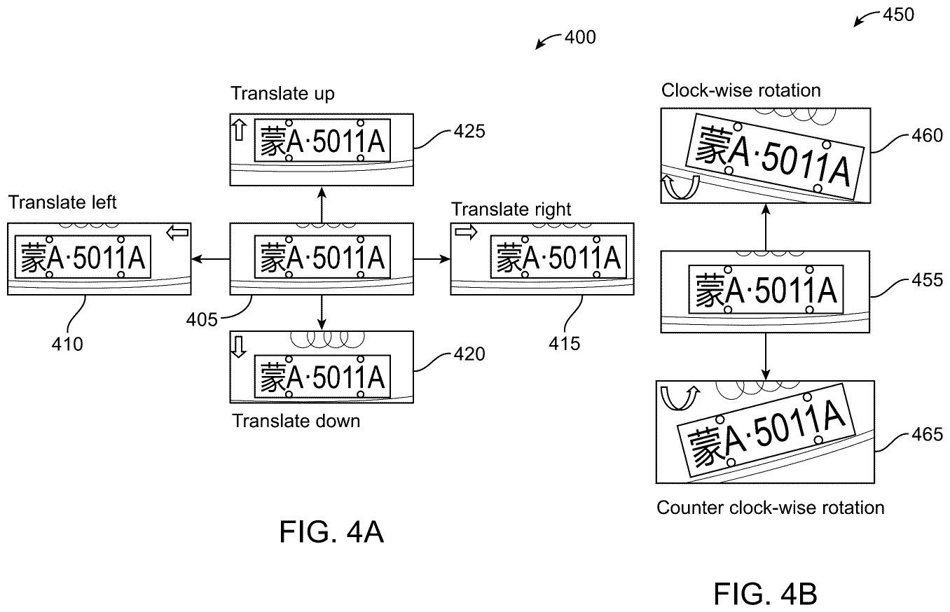

More specifically, each group of one or more groups of sub-images is provided to recognition and deblurring neural network 160 as a separate network input. For example, each group can include multiple sub-images representing the license plate of a first vehicle that has been captured by input data 110. More details of operations performed by the image processing engine 140 are described below in connection with FIGS. 3, 4A, and 4B.

Recognition and deblurring neural network 160 is configured to generate output data 180 after processing the processed image data 150. Recognition and deblurring neural network 160 includes multiple neural network layers to perform respective operations. More specifically, recognition and deblurring neural network 160 can include a first set of neural network layers configured to receive processed image data 150 as input, which generally includes sub-images representing a particular license plate. Recognition and deblurring neural network 160 is configured to generate feature embeddings for the sub-images. Recognition and deblurring neural network 160 can further include a second set of neural network layers configured to generate one or more rectification parameters that, once applied to feature embeddings, rectify the feature embeddings in the feature space. The rectification parameters are intermediate results generated by the second set of neural network layers and are not included in output data 180. Since the rectification parameters are not directly applied to images and are not the final output of recognition and deblurring neural network 160, license plate processing system 100 can be more efficient compared to existing techniques which oftentimes require two distinct neural networks for reciting images and processing rectified images, respectively.

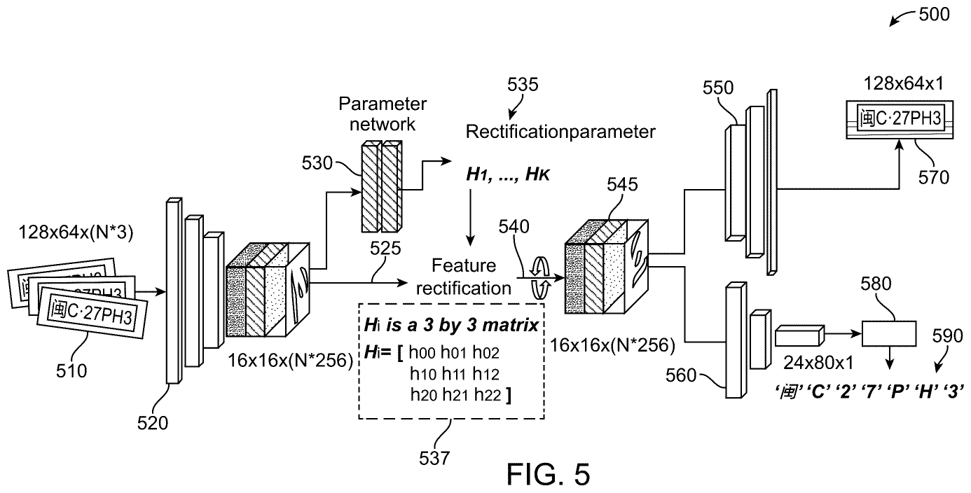

Recognition and deblurring neural network 160 is configured to perform more than one task. For example, the tasks can include recognizing the content of objects of interest (e.g., the content of a license plate), deblurring one or more images in the sequence of images (e.g., reconstructing images with higher resolution), etc. To perform multiple different tasks, recognition and deblurring neural network 160 can be designed to include more than one task head. Each head is designed for performing a particular task and includes a respective set of neural network layers. The task heads and other network layers (e.g., the first set of network layers and the second set of network layers as described above) are trained jointly using the same training data subject to a joint loss function. Details of training and using recognition and deblurring neural network 160 are described below in connection with FIG. 5.

In general, output data 180 can include different types of data according to different tasks and requirements. For example, output data 180 can include data representing the content recognized for the object of interest. For a license plate, the content can be represented by strings, letters, characters, integers, or other suitable formatting stored in suitable data structures. As another example, output data 180 can include one or more reconstructed images with higher resolution than those in input data 110. The one or more reconstructed images can be used by downstream operations for different purposes. For example, the one or more reconstructed images can be used to identify a particular vehicle as associated with observed behavior, for example, for further analysis or use in traffic enforcement.

In addition, license plate processing system 100 can further include a memory 190 communicatively coupled with system 100. Memory unit 190 can be local or remote to the license plate processing system 100. In some cases, memory unit 190 is generally configured to store parameters for system 100. For example, memory unit 190 can store model parameters for detector and tracker module 120, image processing engine 140, and recognition and deblurring neural network 160. Memory unit 190 can also provide these stored parameters to system 100 for performing inference operations. In addition, the memory unit 190 may optionally be configured to store and provide input data 110 to system 100, or temporarily store output data 180, or both.

System 100 can be communicatively coupled to a server 195. Server 195 generally receives user requests for performing operations using license plate processing system 100. In some cases, server 195 can generate instructions to train system 100 or the recognition and deblurring neural network 160 of system 100. Server 195 can provide hyperparameters for training system 100. Server 195 can also provide initial model parameters as a starting point for training. The initial model parameters can include previously trained parameters, pre-determined parameters, or parameters that are generated using a particular algorithm (e.g., a randomness model). In some cases, parameters can be stored in memory 190 local to system 100. In these cases, server 195 can instruct system 100 to fetch parameters from memory 190 for training and update parameters stored in memory 190 once the training is completed. Alternatively, the server 195 may correspond to another suitable type of computing device.

FIG. 2 illustrates an example detector and tracker module 200 configured to generate tracking IDs and location data 220 after processing image frames 210. The example detector and tracker module 200 can be similar to the detector and tracker module 120 of FIG. 1. The tracking IDs and location data 220 can be similar to the tracking IDs and location data 130 of FIG. 1. The input image frames 210 can be similar to input data 110 of FIG. 1.

As shown in FIG. 2, input image frames 210 can include two or more image frames according to a sequence. The image frames 210 can be captured by an image camera or a video camera in real time, as described above. Each of the image frames 210 can capture a scene of multiple objects of interest. For example and as shown in FIG. 2, one image frame can include multiple vehicles (e.g., trucks, sedans, or other vehicles) maneuvering on a highway. The image also captures license plates associated with the multiple vehicles. Since the vehicles are moving in real-time, the vehicles can enter and exit the field of view of the corresponding camera in real-time, e.g., as they pass through the field of view of a stationary camera. Accordingly, a particular vehicle usually appears in a couple of image frames of the entire sequence of image frames 210.

Detector and tracking module 200 is configured to process input image frames 210 to generate tracking IDs and location data 220. In general, detector and tracking module 200 is configured to detect a particular license plate in the sequence of image frames 210, determine a particular tracking ID for the particular license plate, and determine location information (e.g., a bounding box including relevant pixels in each image) representing the particular license plate. The detector and tracking module 200 is then configured to group the tracking ID and the location information to be stored in a particular data structure. For example and as shown in FIG. 2, each tracking ID and corresponding location information is stored in a data buffer 230. The tracking IDs and corresponding location information can be labeled as one, two, three, or K (a number greater than three) and stored in a respective data structure in data buffer 230, as shown in FIG. 2. Note that the illustration in FIG. 2 is for ease of description. The labels and data structures for storing the tracking IDs and corresponding location information are generally determined according to different requirements for processing input image frames.

As a more concrete example, the input image frames 210 can include a sequence of ten image frames. A first vehicle and a first license plate are captured in the first four image frames, a second vehicle and a second license plate are captured in the third to seventh image frames, and a third vehicle and a third license plate are captured in the last five image frames. For the first vehicle, detector and tracker module 200 is configured to assign a first tracking ID to the first license plate and determine a respective bounding box representing the first license plate in each of the first four image frames. For the second vehicle, detector and tracker module 200 is configured to assign a second tracking ID to the second license plate and determine a respective bounding box representing the second license plate in each of the third to seventh image frames. For the third vehicle, detector and tracker module 200 is configured to assign a third tracking ID to the third license plate and determine a respective bounding box representing the third license plate in each of the last five image frames. The first tracking ID and corresponding location information data can be stored in “tracking ID 1” of the data buffer 230. The second tracking ID and corresponding location information data can be stored in “tracking ID 2” of the data buffer 230. The third tracking ID and corresponding location information data can be stored in “tracking ID 3” of the data buffer 230. The data buffer 230 can be a first-in-first-out (FIFO) queue or other suitable data structure.

Detector and tracking module 200 can implement different algorithms for tracking a particular license plate across different image frames. For example, detector and tracking module 200 can implement deep learning detection algorithms such as Single Shot Detector (SSD), the FasterRCNN model, YOLO algorithm and its variant, Kalman filtering, Simple Online Realtime Tracking (SORT) algorithm, Siamese network, or other suitable techniques. Detector and tracking module 200 is further configured to discard generated output if the output does not satisfy a particular criterion. For example, the detector and tracking module 200 is configured to determine a license plate detection score for each output and compare it against a threshold value. Once the license plate detection score of a particular output is less than the threshold value, the detector and tracking module 200 removes the particular output.

FIG. 3 illustrates an example image processing engine 300 configured to generate processed image data 360 for tracking IDs and location data 310. The image processing engine 300 may be equivalent or similar to the image processing engine 140 of FIG. 1. The processed image data 360 may be equivalent or similar to the processed image data 150 of FIG. 1. The tracking IDs and location data 310 may be equivalent or similar to the tracking IDs and location data 130 of FIG. 1.

Image processing engine 300 includes a preprocessing engine 315 for processing tracking IDs and location data 310. More specifically, preprocessing engine 315 is configured, according to one or more criteria, to select a subset of each group of sub-images for a particular license plate in the tracking IDs and location data 310. For example, the preprocessing engine 315 can select a predetermined number of sub-images for each license plate. The predetermined number can be two, three, five, ten, or other suitable numbers.

The one or more criteria can include a first criterion related to a size value of a bounding box representing a license plate. Preprocessing engine 315 compares the bounding box sizes of sub-images for a particular license plate with a threshold size value, and selects sub-images for the particular license plate that are greater than or equal to the threshold size value. The threshold size value can be a pixel width of 30 pixels, 50 pixels, 70 pixels, or other suitable width or height of pixels.

The one or more criteria can include a second criterion related to a quality value of sub-images for a particular license plate. Preprocessing engine 315 is configured to evaluate a quality value for each sub-image of all sub-images representing the particular license plate, and compare the quality values against a threshold quantity value. Preprocessing engine 315 is configured to filter out sub-images with quality values less than the threshold quality value. To determine a quality value for a sub-image, preprocessing engine 315 can implement a Laplacian operator to determine an average frequency score for the sub-image. In general, a higher average frequency score represents a higher quality value, and a lower average frequency score represents a lower quality value. The Laplacian operator can be represented by Equation (1) below:

$$Laplacian = [ \begin{matrix}0 & - 1 & 0 \\ - 1 & 4 & - 1 \\ 0 & - 1 & 0\end{matrix} ] . \qquad Equation ( 1 )$$

After preprocessing engine 315 examines all sub-images of all groups representing different license plates, image processing engine 300 determines, for each license plate of all license plates, whether there are more than N candidate sub-images for the license plate satisfying the above-noted size and quality criteria (320). As described above, the value of N can be two, three, five, ten, or other suitable values.

In response to determining that there are more than N candidate sub-images satisfying the above-noted criteria, image processing engine 300 selects the best N sub-images of all candidate sub-images (330). For example, image processing engine 300 ranks all candidate sub-images based on quality values, size values, or both. The system then selects the top N sub-images according to the ranking. Image processing engine 300 further processes the selected best N sub-images, for example, by performing one or more of: cropping out pixels irrelevant to the particular license plate, adjusting the contrast in the sub-images, adjusting the saturation of the sub-images, or resizing the sub-images to attain a desired input size for downstream operations. The processed image data 360 are provided to a neural network for further operations.

In response to determining that there are fewer than N candidate sub-images satisfying the above-noted criteria, image processing engine 300 augments one or more candidate sub-images to reach N sub-images. Image processing engine 300 can include an image augmentation engine 350 configured to implement one or more different augmentation techniques for candidate sub-images. Image processing engine 300 then processes the augmented sub-images in a similar manner as described above to generate processed image data 360. More details of example augmentation algorithms are described immediately below in connection with FIGS. 4A and 4B.

FIG. 4A illustrates examples 400 of translational augmentation of location data. As shown in FIG. 4A, sub-image 405 represents a particular license plate in an image frame of a sequence of image frames. The sub-image 405 is obtained by location information that generally defines a bounding box of the image frame. An image augmentation engine, e.g., image augmentation engine 350, is configured to augment sub-image 405 by translating the bounding box in various directions, e.g., combinations of translational motion defined by 2D coordinates (e.g., x and y coordinates). For example, image augmentation engine 350 can translate the bounding box to the left to obtain a first augmented sub-image 410 or translate the bounding box to the right to obtain a second augmented sub-image 415. As another example, image augmentation engine 350 can translate the bounding box upward to obtain a third augmented sub-image 425 or translate the bounding box downward to obtain a fourth augmented sub-image 420. The translational augmentation algorithm implemented by image augmentation engine 350 can include a translational matrix with values for translating the bounding box in the sub-image 405.

An example translation matrix is presented by Equation (2) below:

$${H}_{t} = [ \begin{matrix}1 & 0 & {t}_{x} \\ 0 & 1 & {t}_{y} \\ 0 & 0 & 1\end{matrix} ] . \qquad Equation ( 2 )$$

Here, terms tₓ and t_{y} relate to the amount of translation in the horizontal direction and vertical direction. Hₜ corresponds to an example translational matrix.

FIG. 4B illustrates examples 450 of rotational augmentation of location data. In addition to those described above in connection with FIG. 4A, image augmentation engine 350 can further augment a sub-image by rotating the corresponding bounding box. As shown in FIG. 4B, image augmentation engine 350 is configured to rotate a bounding box in sub-image 455 clockwise in the plane of the image to obtain a fifth augmented sub-image 460 or rotate the bounding box in sub-image 455 counterclockwise in the plane of the image to obtain a sixth augmented sub-image 465. The rotational augmentation algorithm implemented by image augmentation engine 350 can include a rotational matrix with values for rotating the bounding box in sub-image 455.

An example rotational matrix is presented by Equation (3) below:

$${H}_{r} = [ \begin{matrix}cos α & - sin α & 0 \\ sin α & - cos α & 0 \\ 0 & 0 & 1\end{matrix} ] . \qquad Equation ( 3 )$$

Here, the term alpha relates to the amount of rotation in a counterclockwise or clockwise direction. Hᵣ corresponds to an example rotational matrix.

FIG. 5 illustrates an example neural network 500 for processing a network input. The example neural network 500 may be equivalent or similar to the recognition and deblurring neural network 160 of FIG. 1.

As shown in FIG. 5, neural network 500 is configured to process network input 510 and generate different outputs for network input 510. The network input 510 is a set of sub-images for a particular license plate. Each sub-image in the set can have a size of 128 pixels by 64 pixels.

The neural network 500 can include multiple sets of neural network layers for performing different operations. For example, neural network 500 can include a first set of network layers 520, a second set of network layers 530, a third set of network layers 545, a fourth set of network layers 550, and a fifth set of network layers 560. One or more sets of network layers can include residual blocks, and can include one or more different models such as a residual network, an inception network, a MobileNet, or other suitable models.

As described above, neural network 500 is more efficient in processing image frames since it integrates the image rectification process in a single neural network and the rectification operations are performed on embeddings instead of images. More specifically, the first set of network layers 520 is configured to process the network input 510 to generate one or more feature embeddings 525 for the sub-images in a feature space. The second set of network layers 520 (or rectification network layers) can be implemented to process the one or more embeddings 525 to predict rectification parameters 535. The predicted rectification parameters 535 can be formatted in a matrix form as shown in FIG. 5, e.g., a rectification matrix 537. Different sub-images can be fused and aligned by applying the rectification matrix 537 to their corresponding embeddings 525 in the embedding space to obtain rectified embeddings 540. Rectified embeddings 540 are also in the feature space, which generally correspond to rectified sub-images in the sequence of images.

Neural network 500 can further optimize the predicted rectification parameters 535 for optimized recognition and deblurring results. For example, the rectification parameters 535 (and optionally, the corresponding rectification matrix 537) can be finetuned together with the neural network 500 when processing finetuning training data. During the finetuning process, the rectification parameters are treated as network weights and are updated using a particular loss function that is based on a difference/distance between predicted outputs and reference outputs. For example, the loss function can be based on a difference between the resolution of the reconstructed images (e.g., reconstructed sub-images 570) and the reference images, or a level of accuracy of the predicted plate numbers or characters. In some implementations, the loss function can be a joint loss function based on both the resolution and the level of accuracy. A more detailed description of the loss function is presented below.

The rectified embeddings 540 are provided as input to the third set of network layers 545 to obtain an output used by different task heads. Neural network 500 can include two branches of task heads. The first branch task head relates to recognizing content in sub-images, and the second branch task head relates to reconstructing sub-images with higher resolutions. As shown in FIG. 5, the second task head can include the fourth set of network layers 550 configured to reconstruct one or more sub-images 570 with higher resolutions. In addition, the first task head can include the fifth set of network layers 560 configured to recognize initial content in the sub-image 580. Neural network 500 can be further configured to process the initial content by removing redundant and/or superfluous information to generate textual output content 590. The output content 590 and reconstructed sub-images 570 are provided as final output of the neural network 500, as described above.

The first branch task head configured to perform content recognition (i.e., 560) can be implemented using, for example, Connectionist Temporal Classification (CTC) algorithm. In general, the CTC algorithm returns with a label sequence that is mostly likely within the probability distribution. The CTC algorithm is also capable of removing redundant occurrences and superfluous characters (e.g., blank spaces) in the label sequence. For example, a sequence of “aa_ab_” (e.g., 580), where “_” represents a blank space, is modified by the CTC algorithm to return a sequence of “aab” (e.g., 590). The recognition branch can further set a specified length of a generated label sequence, e.g., five, seven, eight, ten, or other suitable numbers of characters.

Regarding the second branch task head configured to perform content deblurring (i.e., 550), the reconstructed sub-images 570 are generally of enhanced quality than sub-images 510. The output from the deblurring branch 550 can be configured to generate images with higher averaged frequency scores. The reconstructed images can be in RGB format.

The neural network 500 can use only the recognition branch 560 since, in some cases, the deblurring branch 550 can be unnecessary for a particular task. In some applications, the neural network 500 can be void of a beblurring branch 550. For example, the deblurring branch 550 is not necessary if the system is applied for scenarios where vehicles move slowly (e.g., vehicles maneuvering on a local street). Thus, the deblurring branch 550 can be pruned for a more efficient and faster neural network.

The neural network 500 is trained jointly on common training data using a joint loss function. The joint loss function can be a weighted sum of two different loss functions. The first loss function can be a recognition loss function formulated to account for errors generated in the recognition branch. The second loss function can be a deblurring loss function formulated to account for errors generated in the deblurring branch.

Thus, the joint loss function Lⱼₒᵢₙₜ can be a weighted sum presented by Equation (4) below:

$${L}_{joint} = {L}_{recog} + β {L}_{deblur} . \qquad Equation ( 4 )$$

The term β is a predetermined weight value, L_{recog} represents the recognition loss function for the recognition branch, and L_{deblur} represents the deblurring loss function for the deblurring branch. The recognition loss function can be a log loss determined based on the predicted characters in a sequence and reference characters in the sequence.

The recognition loss function can be represented by Equations (5) and (6) below:

$${L}_{recog} = - {\sum }_{( x , z ) ∈ S} ln ( P ( z \vert x ) ) , \qquad Equation ( 5 )$$

$$where P ( z \vert x ) = {\prod }_{t = 1}^{L} {p}_{π}^{t} \qquad Equation ( 6 )$$

Here, the term “z” represents a particular labelling path. The term “x” represents a particular input sequence. The term “P(z|x)” represents the conditional probability of the output target sequence z in view of the particular input x. The term “S” represents the training dataset. The term “L” represents the length of a feature sequence for generating the output sequence. The term “π” represents a particular path that is observed in generating the output sequence. For example, to calculate the recognition loss, the system can set the length of a final feature to include 25 characters for output sequences that normally include 8 or 9 characters.

On the other hand, the deblurring loss function can be an L2 loss. For example, the system can measure a squared difference between pixels of reconstructed images and pixels of reference images.

An example deblurring loss function can be represented in Equation (7) below:

$${L}_{deblur} = \frac{1}{n} {\sum }_{i = 1}^{n} {( {Y}_{i} - {Y}_{i}^{′} )}^{2} , \qquad Equation ( 7 )$$

where the term “Yᵢ” represents a reference value of a patch of an image and the term “Yᵢ′” represents a predicted value of the corresponding patch of a predicted image. The values can relate to average RGB values, sharpness values, or other suitable values.

In some implementations, during each iteration of the training process, the system processes each set of training sub-images to predict a respective pair of outputs (e.g., recognized content and deblurred images) using predetermined hyper parameters and initial model parameters. The system repeatedly updates the initial model parameters by minimizing the joint loss function for each pair of predicted output until a stopping point. The stopping point can be a convergence point or a predetermined number of iterations. Since the joint loss function implicitly accounts for errors generated in the rectification process by the rectification network layers, the model parameters for the rectification network layers are also jointly obtained in the training.

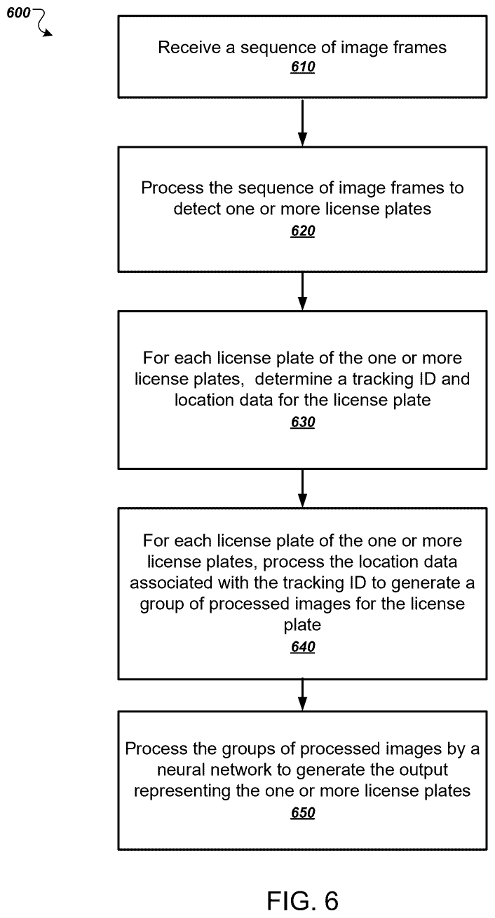

FIG. 6 is a flow diagram of an example process 600 for processing image frames. For convenience, the example process 600 is described as being performed by a system of one or more computers located in one or more locations. For example, the license plate processing system 100 of FIG. 1, when appropriately programmed, can perform the process 600.

The system receives a sequence of image frames (610). As described above, the system is configured to process a sequence of image frames in real-time. The sequence of image frames can be provided to the system by one or more corresponding image sensors (e.g., cameras) immediately after collecting image frames. The image sensors can include a video image located on a vehicle, a video camera located above a particular highway, or other suitable sensors located at other suitable positions.

The sequence of image frames can be provided to the system as a stream of image frames for a period of time. For example, the sequence of image frames can include five, ten, twenty, fifty, or other suitable numbers of image frames for a period of two seconds, five seconds, ten seconds, or other suitable amount of time.

The system processes the sequence of image frames using a first module to detect one or more objects in the images, e.g., license plates (620). As described above, the first module can be similar to the detector and tracker module 120 of FIG. 1. The first module is configured to detect license plates that are captured in each image frame of the sequence of image frames. For example, for a sequence of image frames with ten frames, the first module can determine two license plates in the first three image frames, five license plates in the fourth to seventh image frames, and two license plates in the eighth to tenth image frames.

For each license plate of the one or more license plates, the system determines, by the first module, a tracking ID and location data for the license plate (630). As described above, the first module is configured to determine a particular tracking ID for each license plate detected in the sequence of image frames. Each tracking ID is unique to a particular license plate and maintained unchanged for the particular license plate across different image frames.

In addition, for each license plate and corresponding image frames that capture the license plate, the first module is configured to determine location data that identifying pixels representing the license plate. For example, the location data for each license plate in a corresponding image frame can be a bounding box in the image frame that crops out other pixels that do not carry information related to the license plate. The remaining pixels for the bounding box are also referred to as a sub-image of the image frame. The location data and tracking IDs of the license plates are provided as output (e.g., tracking IDs and location data 130) of the first module and processed by a second module. In some implementations, the system stores the tracking IDs and the location data for the one or more license plates in a data buffer according to a particular ordering. The system provides the data stored in the data buffer to the second module according to the order.

For each license plate of the one or more license plates, the system processes, the location data associated with the tracking ID by the second module to generate a group of processed images for the license plate (640). The second module can be similar or equivalent to image processing engine 140 of FIG. 1. As described above, the second module is configured to obtain candidate sub-images by filtering out sub-images that do not satisfy one or more predetermined criteria. The one or more predetermined criteria can include a quality criterion, a size criterion, or other suitable criteria. The second module is further configured to determine if the total number of candidate sub-images satisfies a predetermined quantity requirement. The predetermined quantity requirement can include a threshold quantity number N for each license plate, where N can be two, three, five, or other suitable numbers.

In response to determining that the number of candidate sub-images satisfies the predetermined quantity requirement (e.g., the number is greater than N), the system ranks all candidate sub-images for the license plate according to a particular measure such as a quality value, a size value, or both. The system selects the top N sub-images and further processes the selected top N sub-images to generate a group of processed images for the license plate. Image processing operations that are applied by the system to selected sub-images can include cropping out pixels irrelevant to the particular license plate, adjusting the contrast in the sub-images, adjusting the saturation of the sub-images, resizing the sub-images to attain a desired input size for downstream operations, or other suitable operations.

In response to determining that the number of candidate sub-images do not satisfy the predetermined quantity requirement (e.g., the number is less than N), the second module is configured to perform augmentation techniques to generate more sub-images based on the candidate sub-images to have N sub-images for each license plate. Augmenting a sub-image of the sub-images generally relates to adjusting a position or orientation of a bounding box that captures the corresponding license plate in a corresponding image of the sequence of images. And the adjusted bounding box defines an augmented sub-image. Augmentation techniques can include, for example, translational and rotational augmentation techniques, as described above. The system further processes the augmented sub-images by operations as described above to generate a group of processed images for the license plate, which is also referred to as a network input to be processed by a neural network.

The system processes the groups of processed images using a neural network to generate output that represents one or more license plates (650). The neural network can be similar or equivalent to the recognition and deblurring neural network 160 of FIG. 1, or the neural network 500 of FIG. 5. As described above, the neural network can include a first sequence of neural network layers configured to generate an embedding for each group of the groups of processed images; and a second sequence of neural network layers configured to process each of the embeddings to generate respective rectification parameters for rectifying the embedding. The respective rectification parameters can be formatted as a rectification matrix with one or more entries. The system can rectify corresponding embeddings for a license plate in the feature space by multiplying the embedding with the rectification matrix. The second sequence of neural network layers can be similar to or equivalent to the rectification network layers 530 of FIG. 5.

The neural network further includes a third sequence of neural network layers succeeding the first sequence of neural networks and the second sequence of neural networks. The third sequence of neural network layers are configured to process the rectified embeddings to generate the reconstructed images for the one or more license plates. The third sequence of neural network layers can be similar or equivalent to the set of network layers 550 in the deblurring branch.

The neural network further includes a fourth sequence of neural network layers succeeding the first sequence of neural networks and the second sequence of neural networks. The fourth sequence of neural network layers are configured to process the rectified embeddings to generate the predictions of content for the one or more license plates. The fourth sequence of neural network layers can be similar or equivalent to the set of network layers 560 in the recognition branch.

The model parameters of the neural network are jointly trained using a loss function. The loss function includes a first loss function representing errors in predicting the content of license plates in training images; and a second loss function representing errors in generating reconstructed images of license plates in the training images.

The term “vehicle license plate” throughout the specification refers to a plate attached to a vehicle for official identification purposes. The term “vehicle,” as described above, stands for all kinds of vehicles that are navigating on public roads, including motor vehicles such cars, trucks, motorcycles, or tractors. The vehicle license plate for each vehicle includes a sequence of characters (i.e., textual content) that uniquely identifies a vehicle in a jurisdiction where the vehicle license plate is issued. The sequence of characters can have different types and lengths for different jurisdictions. For example, a sequence of characters can be a single-row, a double-row, or a multiple-row. As another example, the sequence of characters can have a length of one or more characters, e.g., 2, 4, 7, 9, and 12. For simplicity, the term “vehicle license plate” is generally referred to as a “license plate” in this specification.

The term “characters” corresponding to an identified license plate throughout the specification stands for a text associated with the license plate. The characters can include a number, a letter, a symbolic character for a particular region (e.g., a Chinese character, a Hindi character, an Arabic character, a Japanese character, or a Korean character), and, optionally, symbols (e.g., a dot between characters, an underscore, or a graphic symbol).

The term “machine learning model” throughout the specification stands for any suitable model used for machine learning. As an example, the machine learning model can include one or more neural networks trained for performing different inference tasks. Examples of neural networks and tasks performed by neural networks are described in greater detail at the end of the specification. For simplicity, the term “machine learning models” is sometimes referred to as “neural network models” or “deep neural networks” in the following specification.

Depending on the task, a neural network can be configured, i.e., through training, to receive any kind of digital data input and to generate any kind of score, classification, or regression output based on the input.

In some cases, the neural network is a neural network that is configured to perform an image processing task, i.e., receive an input image and process the input image to generate a network output for the input image. In this specification, processing an input image refers to processing the intensity values of the pixels of the image using a neural network. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories.

As another example, if the input to the neural network is a sequence of text in one language, the output generated by the neural network may be a score for each of a set of pieces of text in another language, with each score representing an estimated likelihood that the piece of text in the other language is a proper translation of the input text into the other language.

In some cases, the machine learning task is a combination of multiple individual machine learning tasks, i.e., the neural network is configured to perform multiple different individual machine learning tasks, e.g., two or more of the machine learning tasks mentioned above. For example, the neural network can be configured to perform multiple individual image processing or computer vision tasks, i.e., by generating the output for the multiple different individual image processing tasks in parallel by processing a single input image.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language specification, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it, software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method, comprising: receiving a sequence of image frames; and processing the sequence of image frames to generate output representing one or more objects detected in the sequence of image frames, wherein the processing comprises: processing the sequence of image frames using a first module to detect the one or more objects in the sequence of image frames, for each object of the one or more objects: determining a tracking ID and location data for the object; and processing the corresponding location data associated with the tracking ID to generate a group of processed images for the object; and processing the groups of processed images by a neural network to generate the output representing the one or more objects, wherein the output comprises (i) a prediction of content and (ii) a reconstructed image for each object of the one or more objects, wherein the neural network comprises a first sequence of neural network layers and a second sequence of neural network layers, wherein processing the groups of processed images by the neural network comprises: generating an embedding for each group of the groups of processed images using the first sequence of neural network layers; and processing each of the embeddings using the second sequence of neural network layers to generate respective rectification parameters for rectifying the embedding.

Embodiment 2 is the method of Embodiment 1, wherein the sequence of image frames is captured in real time by a camera.

Embodiment 3 is the method of Embodiment 1 or 2, wherein the one or more objects comprise one or more license plates, and the method further comprises: storing the tracking IDs and the location data for the one or more license plates in a data buffer according to an order.

Embodiment 4 is the method of any one of Embodiments 1-3, wherein the location data for the object comprises data indicating a bounding box that defines the object in corresponding images of the sequence of images.

Embodiment 5 is the method of Embodiment 4, wherein processing the corresponding location data associated with the respective tracking ID comprises: determining sub-images from the sequence of images based on the location data; determining that a quantity of the sub-images satisfies a threshold criterion; in response to determining that the quantity of the sub-images satisfies the threshold criterion, ranking the sub-images according to a measurement and selecting one or more sub-images from the sub-images according to the ranking; and processing the selected sub-images to generate the group of processed images for the object.

Embodiment 6 is the method of any one of Embodiments 1-5, wherein processing the location data associated with the respective tracking ID comprises: determining sub-images from the sequence of images based on the location data; determining that a quantity of the sub-images does not satisfy a threshold criterion; in response to determining that the quantity of the sub-images does not satisfy the threshold criterion, augmenting the sub-images to satisfy the threshold criterion; and processing the augmented sub-images to generate the group of processed images for the object.

Embodiment 7 is the method of Embodiment 6, wherein determining sub-images from the sequence of images comprises: generating a set of candidate sub-images from the sequence of images based on the location data; removing candidate sub-images with (i) a size less than a size threshold or (ii) a quality value less than a quality threshold from the set of candidate sub-images; and providing the remaining candidate sub-images as the determined sub-images.

Embodiment 8 is the method of Embodiment 6 or 7, wherein augmenting the sub-images comprises: augmenting a sub-image of the sub-images by adjusting a position or orientation of a bounding box that captures the corresponding object in a corresponding image of the sequence of images, wherein the adjusted bounding box defines an augmented sub-image.

Embodiment 9 is the method of any one of Embodiments 1-8, wherein the neural network further comprises a third sequence of neural network layers succeeding the first sequence of neural network layers and the second sequence of neural network layers, wherein the third sequence of neural network layers is configured to process the rectified embeddings to generate the reconstructed images for the one or more objects.

Embodiment 10 is the method of any one of Embodiments 1-9, wherein the neural network further comprises a fourth sequence of neural network layers succeeding the first sequence of neural network layers and the second sequence of neural network layers, wherein the fourth sequence of neural network layers is configured to process the rectified embeddings to generate the predictions of content for the one or more objects.

Embodiment 11 is the method of any one of Embodiments 1-10, wherein model parameters of the neural network have been jointly trained using a loss function, wherein the loss function comprises: a first loss function representing errors in predicting the content of objects in training images; and a second loss function representing errors in generating reconstructed images of objects in the training images.

Embodiment 12 is the method of any one of Embodiments 1-11, wherein the respective rectification parameters comprise a data matrix with one or more entries, and wherein rectifying the embedding comprises multiplying the embedding with the data matrix.

Embodiment 13 is a system comprising one or more computers and one or more storage devices storing instructions that, when executed by one or more computers, cause the one or more computers to perform respective operations, the operations comprising the method of any one of Embodiments 1-12.

Embodiment 14 is one or more computer-readable storage media storing instructions that, when executed by one or more computers, cause the one or more computers to perform respective operations, the respective operations comprising the method of any one of Embodiments 1-12.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain cases, multitasking and parallel processing may be advantageous.

What is claimed is:

1. A method comprising:
receiving a sequence of image frames; and
processing the sequence of image frames to generate output representing one or more objects detected in the sequence of image frames, wherein the processing comprises:
processing the sequence of image frames using a first module to detect the one or more objects in the sequence of image frames,
for each object of the one or more objects:
determining a tracking ID and location data for the object; and
processing the corresponding location data associated with the tracking ID to generate a group of processed images for the object; and
processing the groups of processed images by a neural network to generate the output representing the one or more objects, wherein the output comprises (i) a prediction of content and (ii) a reconstructed image for each object of the one or more objects,
wherein the neural network comprises a first sequence of neural network layers and a second sequence of neural network layers, wherein processing the groups of processed images by the neural network comprises:
generating an embedding for each group of the groups of processed images using the first sequence of neural network layers; and
processing each of the embeddings using the second sequence of neural network layers to generate respective rectification parameters for rectifying the embedding.

2. The method of claim 1, wherein the sequence of image frames is captured in real time by a camera.

3. The method of claim 1, wherein the one or more objects comprise one or more license plates, and the method further comprises:
storing the tracking IDs and the location data for the one or more license plates in a data buffer according to an order.

4. The method of claim 1, wherein the location data for the object comprises data indicating a bounding box that defines the object in corresponding images of the sequence of images.

5. The method of claim 4, wherein processing the corresponding location data associated with the respective tracking ID comprises:
determining sub-images from the sequence of images based on the location data;
determining that a quantity of the sub-images satisfies a threshold criterion;
in response to determining that the quantity of the sub-images satisfies the threshold criterion, ranking the sub-images according to a measurement and selecting one or more sub-images from the sub-images according to the ranking; and
processing the selected sub-images to generate the group of processed images for the object.

6. The method of claim 1, wherein processing the location data associated with the respective tracking ID comprises:
determining sub-images from the sequence of images based on the location data;
determining that a quantity of the sub-images does not satisfy a threshold criterion;
in response to determining that the quantity of the sub-images does not satisfy the threshold criterion, augmenting the sub-images to satisfy the threshold criterion; and
processing the augmented sub-images to generate the group of processed images for the object.

7. The method of claim 6, wherein determining sub-images from the sequence of images comprises:
generating a set of candidate sub-images from the sequence of images based on the location data;
removing candidate sub-images with (i) a size less than a size threshold or (ii) a quality value less than a quality threshold from the set of candidate sub-images; and
providing the remaining candidate sub-images as the determined sub-images.

8. The method of claim 6, wherein augmenting the sub-images comprises:
augmenting a sub-image of the sub-images by adjusting a position or orientation of a bounding box that captures the corresponding object in a corresponding image of the sequence of images, wherein the adjusted bounding box defines an augmented sub-image.

9. The method of claim 1, wherein the neural network further comprises a third sequence of neural network layers succeeding the first sequence of neural network layers and the second sequence of neural network layers, wherein the third sequence of neural network layers is configured to process the rectified embeddings to generate the reconstructed images for the one or more objects.

10. The method of claim 1, wherein the neural network further comprises a fourth sequence of neural network layers succeeding the first sequence of neural network layers and the second sequence of neural network layers, wherein the fourth sequence of neural network layers is configured to process the rectified embeddings to generate the predictions of content for the one or more objects.

11. The method of claim 1, wherein model parameters of the neural network have been jointly trained using a loss function, wherein the loss function comprises:
a first loss function representing errors in predicting the content of objects in training images; and
a second loss function representing errors in generating reconstructed images of objects in the training images.

12. The method of claim 1, wherein the respective rectification parameters comprise a data matrix with one or more entries, and wherein rectifying the embedding comprises multiplying the embedding with the data matrix.

13. A system comprising one or more computers and one or more storage devices storing instructions that, when executed by one or more computers, cause the one or more computers to perform respective operations, the operations comprising:
receiving a sequence of image frames; and
processing the sequence of image frames to generate output representing one or more objects detected in the sequence of image frames; wherein the processing comprises:
processing the sequence of image frames using a first module to detect the one or more objects in the sequence of image frames,
for each object of the one or more objects:
determining a tracking ID and location data for the object; and
processing the corresponding location data associated with the tracking ID to generate a group of processed images for the object; and
processing the groups of processed images by a neural network to generate the output representing the one or more objects, wherein the output comprises (i) a prediction of content and (ii) a reconstructed image for each object of the one or more objects,
wherein the neural network comprises a first sequence of neural network layers and a second sequence of neural network layers, wherein processing the groups of processed images by the neural network comprises:
generating an embedding for each group of the groups of processed images using the first sequence of neural network layers; and
processing each of the embeddings using the second sequence of neural network layers to generate respective rectification parameters for rectifying the embedding.

14. The system of claim 13, wherein the location data for the object comprises data indicating a bounding box that defines the object in corresponding images of the sequence of images.

15. The system of claim 14, wherein processing the corresponding location data associated with the respective tracking ID comprises:
determining sub-images from the sequence of images based on the location data;
determining that a quantity of the sub-images satisfies a threshold criterion;
in response to determining that the quantity of the sub-images satisfies the threshold criterion, ranking the sub-images according to a measurement and selecting one or more sub-images from the sub-images according to the ranking; and
processing the selected sub-images to generate the group of processed images for the object.

16. The system of claim 13, wherein model parameters of the neural network have been jointly trained using a loss function, wherein the loss function comprises:
a first loss function representing errors in predicting the content of objects in training images; and
a second loss function representing errors in generating reconstructed images of objects in the training images.

17. One or more computer-readable storage media storing instructions that when executed by one or more computers cause the one or more computers to perform respective operations, the respective operations comprising:
receiving a sequence of image frames; and
processing the sequence of image frames to generate output representing one or more objects detected in the sequence of image frames, wherein the processing comprises:
processing the sequence of image frames using a first module to detect the one or more objects in the sequence of image frames,
for each object of the one or more objects:
determining a tracking ID and location data for the object; and
processing the corresponding location data associated with the tracking ID to generate a group of processed images for the object; and
processing the groups of processed images by a neural network to generate the output representing the one or more objects, wherein the output comprises (i) a prediction of content and (ii) a reconstructed image for each object of the one or more objects,
wherein the neural network comprises a first sequence of neural network layers and a second sequence of neural network layers, wherein processing the groups of processed images by the neural network comprises:
generating an embedding for each group of the groups of processed images using the first sequence of neural network layers; and
processing each of the embeddings using the second sequence of neural network layers to generate respective rectification parameters for rectifying the embedding.

18. The one or more computer-readable storage media of claim 17, wherein the location data for the object comprises data indicating a bounding box that defines the object in corresponding images of the sequence of images.

19. The one or more computer-readable storage media of claim 18, wherein processing the corresponding location data associated with the respective tracking ID comprises:
determining sub-images from the sequence of images based on the location data;
determining that a quantity of the sub-images satisfies a threshold criterion;
in response to determining that the quantity of the sub-images satisfies the threshold criterion, ranking the sub-images according to a measurement and selecting one or more sub-images from the sub-images according to the ranking; and
processing the selected sub-images to generate the group of processed images for the object.

20. The one or more computer-readable storage media of claim 17, wherein model parameters of the neural network have been jointly trained using a loss function, wherein the loss function comprises:
a first loss function representing errors in predicting the content of objects in training images; and
a second loss function representing errors in generating reconstructed images of objects in the training images.
